(19) United States
(12) Patent Application Publication
(10) Pub. No.: US 2022/0318890 A1
(43) Pub. Date: Oct. 6, 2022

(54) INDIVIDUAL ARTICLE MANAGEMENT APPARATUS, CONTROL METHOD, AND SYSTEM

(71) Applicant: NEC Corporation, Minato-ku, Tokyo (JP)

(72) Inventor: Jun UCHIMURA, Tokyo (JP)

(73) Assignee: NEC Corporation, Minato-ku, Tokyo (JP)

(21) Appl. No.: 17/615,932

(22) PCT Filed: May 27, 2020
(86) PCT No.: PCT/JP2020/020853

§ 371 Date: Dec. 2, 2021

(30) Foreign Application Priority Data
Jun. 5, 2019 (JP) 2019-105386

(51) Int. Cl. G06Q 30/06

(52) U.S. Cl. CPC G06Q 30/0643

(57) ABSTRACT

An individual article management apparatus (2000) acquires product identification information (10) about a target product and preference information (30) about a user. The individual article management apparatus (2000) generates output information (40), based on the acquired preference information (30) and attribute information about each individual article of a target product determined by the acquired product identification information (10). The output information (40) associated with a product includes a captured image related to one or more individual articles of the product. The individual article management apparatus (2000) determines one or more individual articles having attribute information associated with the acquired preference information from among a plurality of individual articles of a product determined by the acquired identification information, and generates the output information including a captured image related to the determined individual article.

### TECHNICAL FIELD

The present invention relates to purchase of a product.

### BACKGROUND ART

A system for facilitating purchase of a product has been developed. For example, Patent Document 1 discloses a system that achieves sales of a product at a virtual store. In this system, a product is displayed as an image at a virtual store. A user can view an image of each product while moving in a virtual store by a method such as a key operation. Further, when a user selects a product, a product number, a price, specifications, and the like of the product are displayed.

### RELATED DOCUMENT

### Patent Document

[Patent Document 1] Japanese Patent Application Publication No. 2005-196349

### SUMMARY OF THE INVENTION

### Technical Problem

In general, a plurality of individual articles are present for one product. Then, a case where a purchaser of a product desires to select a desired individual article from such a plurality of individual articles and purchase the selected individual article is conceivable. For example, when a cabbage is purchased at a real store, a purchaser selects, from a plurality of displayed cabbages, an individual article desired to be purchased, and purchase the selected individual article. In this regard, presence of such an individual article is not considered at a virtual store in Patent Document 1.

The present invention has been made in view of the problem described above, and one of objects of the present invention is to provide information related to each individual article when a purchaser purchases a product by using a computer system.

### Solution to Problem

An individual article management apparatus according to the present invention includes 1) an acquisition unit that acquires identification information about a product and preference information about a user, and 2) a generation unit that generates, based on the acquired preference information and attribute information about each individual article of a product determined by the acquired identification information, output information including a captured image related to one or more individual articles of the product.

A control method according to the present invention is executed by a computer. The control method includes 1) an acquisition step of acquiring identification information about a product and preference information about a user, and 2) a generation step of generating, based on the acquired preference information and attribute information about each individual article of a product determined by the acquired identification information, output information including a captured image related to one or more individual articles of the product.

A system according to the present invention includes a user terminal, and an individual article management apparatus.

The user terminal 1) receives an input of selecting a product from a user, and outputs identification information about the selected product to the individual article management apparatus, and 2) receives an input of preference information related to a preference of the user, and outputs the input preference information to the individual article management apparatus.

The individual article management apparatus 1) acquires, from the user terminal, the identification information about the selected product and the preference information about the user, and 2) generates, based on the acquired preference information and attribute information about each individual article of a product determined by the acquired identification information, output information including a captured image related to one or more individual articles of the product.

A program according to the present invention causes a computer to execute each step included in the control method according to the present invention.

### Advantageous Effects of Invention

The present invention provides information related to each individual article when a purchaser purchases a product by using a computer system.

### BRIEF DESCRIPTION OF THE DRAWINGS

The above-described object, the other objects, features, and advantages will become more apparent from suitable example embodiments described below and the following accompanying drawings.

FIG. 1 is diagram for describing an outline of an individual article management apparatus according to the present example embodiment.

FIG. 2 is a diagram illustrating a functional configuration of an individual article management apparatus according to an example embodiment 1.

FIG. 3 is a diagram illustrating a computer for achieving the individual article management apparatus.

FIG. 4 is a flowchart illustrating a flow of processing performed by the individual article management apparatus according to the example embodiment 1.

FIG. 5 is a flowchart more specifically illustrating a flow of purchase of a product using the individual article management apparatus.

FIG. 6 is a diagram illustrating the individual article management apparatus that provides a virtual store, and a usage environment of the individual article management apparatus.

FIG. 7 is a diagram illustrating individual article information in a table format.

FIG. 8 is a diagram illustrating a screen on which selection of a product can be performed at a virtual store.

FIG. 9 is a diagram illustrating a screen for inputting a preference of a user.

FIG. 10 is a diagram illustrating the individual article management apparatus including an output unit.

FIG. 11 is a diagram illustrating a screen on which a content of output information being output is displayed.

FIG. 12 is a block diagram illustrating a functional configuration of an individual article management apparatus according to an example embodiment 2.

FIG. 13 is a flowchart illustrating a flow of processing performed by the individual article management apparatus according to the example embodiment 2.

FIG. 14 is a block diagram illustrating a functional configuration of an individual article management apparatus according to an example embodiment 3.

FIG. 15 is a flowchart illustrating a flow of processing performed by the individual article management apparatus according to the example embodiment 3.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted. Further, in each block diagram, each block represents a configuration of a functional unit instead of a configuration of a hardware unit unless otherwise described.

### [Example Embodiment 1]

### <Outline>

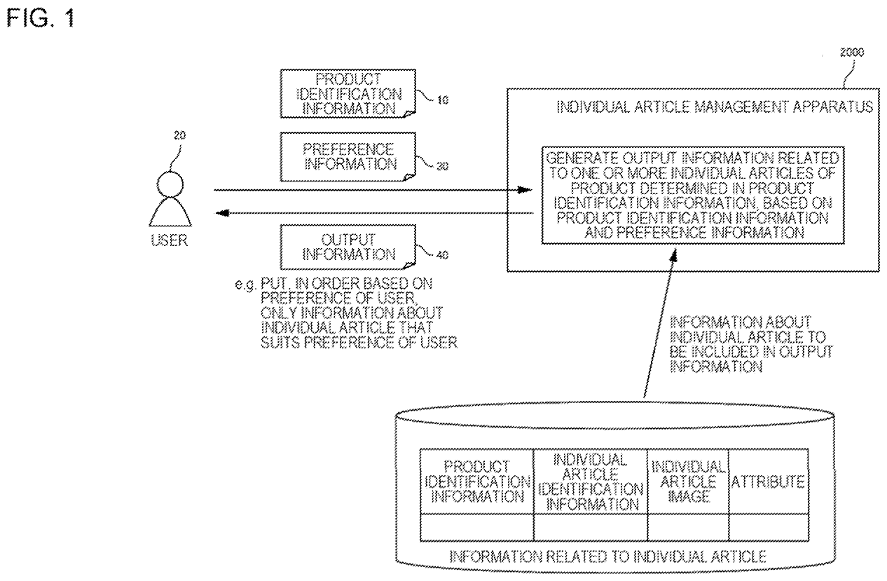

FIG. 1 is diagram for describing an outline of an individual article management apparatus according to the present example embodiment. Note that, FIG. 1 is exemplification for facilitating understanding of an individual article management apparatus 2000, and a function of the individual article management apparatus 2000 is not limited to that illustrated in FIG. 1.

The individual article management apparatus 2000 is used for purchase of a product using a computer system. Herein, for at least one product purchased by using the individual article management apparatus 2000, there is an individual article that may vary in a property and a state even when the individual article belongs to the same product. The individual article is an individual object belonging to a product managed by the same identification information (for example, a Japanese article number (JAN) code). For example, it is assumed that 20 cabbages having a name of “cabbage produced in A prefecture” are displayed at a supermarket. In this case, each of the 20 cabbages is an individual article of a product being “cabbage produced in A prefecture”. Hereinafter, identification information assigned to a product is referred to as product identification information, and identification information assigned to an individual article is referred to as individual article identification information. In the example of the cabbage described above, identification information assigned to each of the 20 cabbages is individual article identification information, and identification information assigned to the product being “cabbage produced in A prefecture” is product identification information.

The individual article management apparatus 2000 outputs information according to a preference of a person (user 20) who purchases a product by using the individual article management apparatus 2000. Specifically, first, the individual article management apparatus 2000 acquires preference information 30 about the user 20. The preference information 30 indicates information related to a preference of the user 20. Further, the individual article management apparatus 2000 acquires product identification information 10 about a target product. The target product is, for example, a product in which the user 20 has an interest (desires to purchase).

The individual article management apparatus 2000 generates output information 40, based on the acquired preference information 30 and attribute information about each individual article of the product (i.e., the target product) determined by the acquired product identification information 10. For example, a captured image (individual article image) related to one or more individual articles of the target product is included in the output information 40. For example, the individual article management apparatus 2000 determines an individual article having an attribute similar to an attribute indicated by the preference information 30 about the user 20 from among a plurality of individual articles of the target product, and generates the output information 40 including an individual article image of the determined individual article.

As a more specific example, it is assumed that there is “pork produced in A prefecture” as a product purchasable by using the individual article management apparatus 2000, and the user 20 is about to purchase the product. Further, it is assumed that the user 20 prefers meat with less fat. In this case, the preference information 30 about the user 20 indicates an attribute being “less fat” as a preference of the user 20 related to meat. Then, for example, the individual article management apparatus 2000 acquires the product identification information 10 about “pork produced in A prefecture” and the preference information 30 indicating an attribute of meat being “less fat”. Then, the individual article management apparatus 2000 determines an individual article with less fat from among a plurality of individual articles of the product being “pork produced in A prefecture”, and generates the output information 40 including an individual article image of the determined individual article.

Note that, the individual article management apparatus 2000 may not be limited to use in so-called business to consumer (B to C), and may be used in business to business (B to B). In the latter case, for example, a wholesaler uses the individual article management apparatus 2000, and provides a product to a retailer. In other words, a retailer lays in a stock of an individual article desired to be sold to a consumer at a store and the like from a wholesaler by using the individual article management apparatus 2000.

### One Example of Advantageous Effect

The individual article management apparatus 2000 according to the present example embodiment generates, based on the product identification information 10 about a target product and the preference information 30 about the user 20, the output information 40 related to one or more individual articles of the target product. By generating the output information 40 in such a manner, information related to each individual article according to the preference information 30 about the user 20 can be provided to the user 20. For example, the individual article management apparatus 2000 generates the output information 40 in such a way as to more preferentially output information related to an individual article that suits a preference of the user 20. In this way, the user 20 can perform selection of an individual article with focus on an individual article that suits his/her preference, and thus convenience of the individual article management apparatus 2000 improves.

Further, an image of an individual article is possible to be included in the output information 40. Thus, the user 20 can visually recognize a feature of each individual article. Accordingly, the user 20 can more easily select an individual article that suits his/her preference.

Hereinafter, the present example embodiment will be described in more detail.

### Example of Functional Configuration

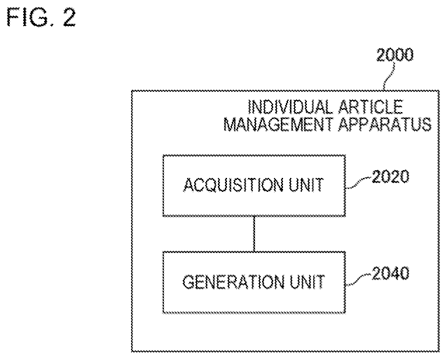

FIG. 2 is a diagram illustrating a functional configuration of the individual article management apparatus 2000 according to an example embodiment 1. The individual article management apparatus 2000 includes an acquisition unit 2020 and a generation unit 2040. The acquisition unit 2020 acquires the product identification information 10, and the preference information 30 about the user 20. The generation unit 2040 generates, based on the acquired preference information 30 and attribute information about each individual article of a product determined by the acquired product identification information 10, the output information 40 including a captured image related to one or more individual articles of the product.

### Example of Hardware Configuration of Individual Article Management Apparatus 2000

Each functional component unit of the individual article management apparatus 2000 may be achieved by hardware (for example, a hard-wired electronic circuit, and the like) that achieves each functional component unit, and may be achieved by a combination of hardware and software (for example, a combination of an electronic circuit and a program that controls the electronic circuit, and the like). Hereinafter, a case where each functional component unit of the individual article management apparatus 2000 is achieved by the combination of hardware and software will be further described.

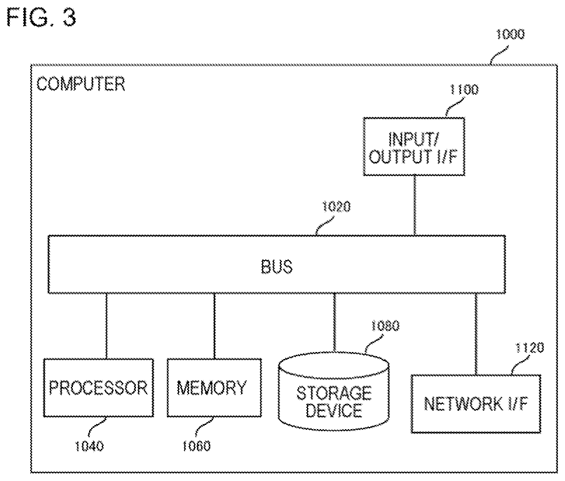

FIG. 3 is a diagram illustrating a computer 1000 for achieving the individual article management apparatus 2000. The computer 1000 is any computer. For example, the computer 1000 is a stationary computer such as a personal computer (PC) and a server machine. In addition, for example, the computer 1000 is a portable computer such as a smartphone and a tablet terminal. Note that, the computer 1000 may be a dedicated computer designed for achieving the individual article management apparatus 2000, and may be a general-purpose computer.

The computer 1000 includes a bus 1020, a processor 1040, a memory 1060, a storage device 1080, an input/output interface 1100, and a network interface 1120. The bus 1020 is a data transmission path for allowing the processor 1040, the memory 1060, the storage device 1080, the input/output interface 1100, and the network interface 1120 to transmit and receive data with one another. However, a method of connecting the processor 1040 and the like to each other is not limited to bus connection.

The processor 1040 is various types of processors such as a central processing unit (CPU), a graphics processing unit (GPU), and a field-programmable gate array (FPGA). The memory 1060 is a main storage apparatus achieved by using a random access memory (RAM) and the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 and an input/output device. For example, an input device such as a keyboard and an output device such as a display device are connected to the input/output interface 1100.

The network interface 1120 is an interface for connecting the computer 1000 to a communication network. The communication network is, for example, a local area network (LAN) and a wide area network (WAN). A method of connection to the communication network by the network interface 1120 may be wireless connection or wired connection.

The storage device 1080 stores a program module that achieves each functional component unit of the individual article management apparatus 2000. The processor 1040 achieves a function associated with each program module by reading each of the program modules to the memory 1060 and executing the program module.

### <Flow of Processing>

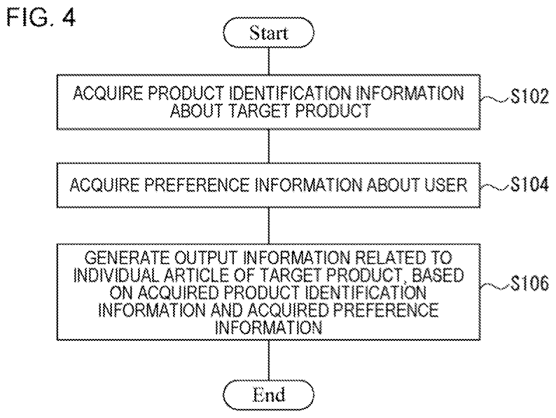

FIG. 4 is a flowchart illustrating a flow of processing performed by the individual article management apparatus 2000 according to the example embodiment 1. The acquisition unit 2020 acquires the product identification information 10 about a target product (S102). The acquisition unit 2020 acquires the preference information 30 about the user 20 (S104). The generation unit 2040 generates, based on the product identification information 10 about the target product and the preference information 30 about the user 20, the output information 40 including a captured image related to one or more individual articles of the target product (S106).

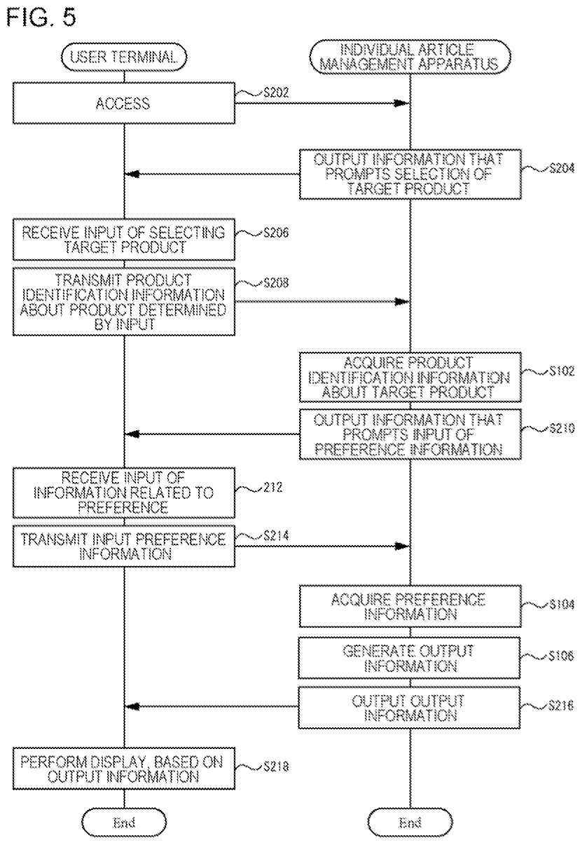

FIG. 5 is a flowchart more specifically illustrating a flow of purchase of a product using the individual article management apparatus 2000. First, a terminal (hereinafter, a user terminal) operated by the user 20 accesses the individual article management apparatus 2000 (S202). For example, the access to the individual article management apparatus 2000 indicates a login and the like to a virtual store and a shopping site described later. The individual article management apparatus 2000 outputs, to the user terminal, information (for example, a selection screen of a product) that prompts an input of selecting a target product (S204). The user terminal receives, from the user 20, the input of selecting the target product. (S206). The user terminal transmits the product identification information 10 about the selected product to the individual article management apparatus 2000 (S208). The acquisition unit 2020 acquires, as the product identification information 10 about the target product, the product identification information 10 transmitted from the user terminal (S102).

The individual article management apparatus 2000 outputs, to the user terminal, information (for example, a selection screen of a preference) that prompts an input of selecting a preference of the user 20 (S210). The user terminal receives, from the user 20, the input representing the preference of the user 20 (S212). The user terminal transmits the received information to the individual article management apparatus 2000 (S214). The acquisition unit 2020 acquires, as the preference information 30, the information transmitted from the user terminal (S104).

Note that, the preference information 30 may be registered in advance for each user 20 instead of being input every time a target product is selected. In this case, the individual article management apparatus 2000 acquires the preference information 30 being stored in a storage apparatus. A variation of methods of acquiring the preference information 30 will be described later.

The individual article management apparatus 2000 generates the output information 40, based on the acquired product identification information 10 and the acquired preference information 30 (S106). The individual article management apparatus 2000 outputs the output information 40 to the user terminal (S216). The user terminal acquires the output information 40, and performs display, based on the output information 40 (S218).

For example, the output information 40 includes only information having a high degree of association with the preference information 30 among individual articles determined by the product identification information 10. In this case, only information about an individual article that suits a preference of the user 20 is displayed on the user terminal.

### Usage Example

Herein, a usage manner of the individual article management apparatus 2000 is more specifically illustrated. However, a manner in which the individual article management apparatus 2000 is achieved is not limited to the specific example illustrated herein.

### Usage Example 1

For example, the individual article management apparatus 2000 provides a store in a virtual space (hereinafter, a virtual store) to the user 20. The user 20 can do the shopping by moving around at a virtual store in a virtual space. In this way, the user 20 can do the shopping with a sense as if the user 20 does the shopping at a real store even without going to a real store. Note that, as a technique for providing, to a user, a sense of moving around in a two-dimensional or three-dimensional virtual space, an existing technique related to virtual reality (VR) can be used.

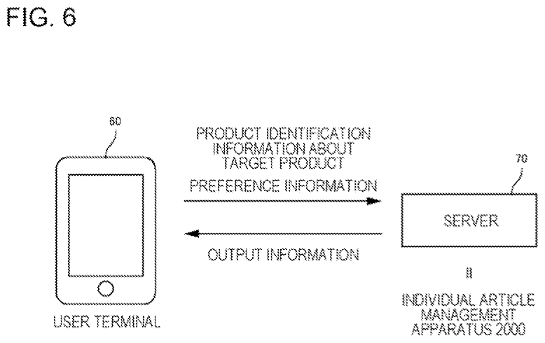

FIG. 6 is a diagram illustrating the individual article management apparatus 2000 that provides a virtual store, and a usage environment of the individual article management apparatus 2000. In this example, the individual article management apparatus 2000 is achieved by a server 70. The server 70 provides, to the user 20, a site (for example, a web site) in which a virtual store can be used. The user 20 uses a virtual store by accessing the site by using a user terminal 60 (for example, a portable terminal possessed by the user 20). Note that, similarly to the individual article management apparatus 2000, a hardware configuration of the user terminal 60 can be achieved by various computers illustrated in FIG. 3.

Similarly to a real store, various salesrooms of products are provided in a virtual store. The user 20 moves to a salesroom where a desired product is located by moving inside the virtual store through a predetermined operation (such as a touch operation on a touch panel). Herein, the individual article management apparatus 2000 may provide, to the user 20, an operation of being able to more easily move to a desired salesroom. For example, the individual article management apparatus 2000 provides a function of being able to select a salesroom from a map of a virtual store. When a salesroom is selected on the map, a position of the user 20 at the virtual store is changed to the selected salesroom. In addition, for example, the individual article management apparatus 2000 may provide a function of searching for a product, and change a position of the user 20 to a salesroom of a product determined by the search.

In the virtual store, information about a product included in a screen (i.e., a field of view of the user 20 in a virtual space) displayed on a display device of the user terminal 60 is displayed. The user 20 selects a desired product from among products displayed on the screen. The individual article management apparatus 2000 acquires, as the product identification information 10 about the target product, the product identification information 10 about the product selected herein.

Furthermore, the individual article management apparatus 2000 acquires the preference information 30 about the user 20, and generates the output information 40, based on the product identification information 10 about the target product and the preference information 30 about the user 20. As a result, for example, only information related to an individual article that suits a preference of the user 20 among individual articles of the product selected by the user 20 is displayed on the screen. The user 20 selects an image of a desired individual article from among images displayed on the screen. The selected individual article is added to an intended purchase list described later, for example.

In this way, the user 20 can select a product and an individual article of the product by moving around inside a virtual store as if the user 20 does the shopping at a real store. Herein, as one of advantages of doing the shopping at a real store, each individual article can be compared, and a desired individual article can be selected. In this regard, selection of an individual article can be performed at a virtual store provided by the individual article management apparatus 2000, and thus the user 20 can do the shopping with a sense similar to a sense of doing the shopping at a real store. Furthermore, narrowing down and the like of an individual article using the preference information 30 about the user 20 can be performed, and thus selection of an individual article is easier than that when the user 20 does the shopping at a real store. Thus, the user 20 can more easily do the shopping than shopping at a real store while enjoying a sense of shopping at a real store.

### Usage Example 2

The individual article management apparatus 2000 does not necessarily need to provide a virtual store. For example, the individual article management apparatus 2000 provides a shopping site in which a desired product can be searched by following a menu or performing a keyword search. Also in this case, the individual article management apparatus 2000 can be achieved as the server 70.

When a plurality of individual articles of a product are present in a shopping site, the user 20 can select a desired individual article. At this time, information (the output information 40 described above) about an individual article provided in the shopping site is generated by using the preference information 30 about the user 20.

For example, it is assumed that, in a shopping site, the user 20 finds a desired product by a method of following a menu and the like, and performs an input of selecting the product. The individual article management apparatus 2000 acquires, as the product identification information 10 about a target product, identification information about the product specified herein. Then, the individual article management apparatus 2000 outputs the output information 40 related to each individual article of the target product. As a result, a screen representing a content of the output information is displayed in the shopping site.

At this time, for example, the individual article management apparatus 2000 outputs the output information 40 including only information about an individual article that suits a preference of the user 20 among the individual articles of the target product. Thus, in the shopping site, only the information about the individual article that suits the preference of the user 20 is displayed instead of information about all of the individual articles of the target product.

In this way, selection of an individual article is performed in a shopping site provided by the individual article management apparatus 2000. Thus, the user 20 can select an individual article that more suits a his/her preference compared with in a general shopping site in which only selection of product units can be performed. Further, the output information 40 including information about an individual article is generated based on the preference information 30, and thus selection of an individual article is easier.

### <Usage Manner 3>

The user terminal 60 is not limited to a terminal possessed by the user 20. For example, a terminal installed at a real store can be used as the user terminal 60. For example, when an individual article that suits a preference is not located in a salesroom at a real store, a customer who visits the real store can access a virtual store and a shopping site (hereinafter, a virtual store and the like) by using the user terminal 60 installed at the store. As described later, for example, at a virtual store and the like, an individual article located in a stockroom at a real store can be viewed. In this way, a customer can search for an individual article that suits a preference from not only an individual article arranged in a salesroom but also an individual article located in a stockroom.

Note that, when an individual article located in a stockroom is selected at a virtual store and the like, the individual article may be handed over to the user 20 at the store, or may be delivered to a home or the like of the user 20. In the former case, for example, information related to the individual article selected by the user 20 via the virtual store and the like is notified to a terminal installed in the stockroom. Then, a salesclerk who recognizes the notification takes out the selected individual article from the stockroom, and passes the individual article to the user 20.

<Relationship with Real Store>

An individual article handled by the individual article management apparatus 2000 may not only be purchased via the individual article management apparatus 2000, but may also be purchased at a real store. However, in a case where an individual article located in a salesroom at a real store is also set to be purchasable via the individual article management apparatus 2000, when a salesclerk is about to perform an operation (so-called picking) of taking, from a salesroom, an individual article purchased via the individual article management apparatus 2000, there is a possibility that a customer who visits the real store has already taken the individual article from the salesroom.

Then, it is preferable that the individual article management apparatus 2000 handles an individual article located in a stockroom at a real store (i.e., an individual article that is not yet located in a salesroom). Specifically, an individual article is handled as follows. First, while an individual article is located in a stockroom, the individual article is in a state of being purchasable via the individual article management apparatus 2000. In other words, information about the individual article may be included in the output information 40. Meanwhile, when the individual article is moved from the stockroom to a salesroom at a store, the individual article is brought into a state of being unpurchasable via the individual article management apparatus 2000. In other words, information about the individual article moved to the salesroom is not included in the output information 40. Note that, a method of managing whether an individual article is purchasable will be described later.

### <With Regard to Product and Individual Article>

As typified by the cabbage described above and the like, there may be an individual article that varies in a property and a state even when the individual article belongs to the same product. When a real store is used, it is conceivable that a customer often compares several individual articles and selects an individual article that more suits a preference. Then, the individual article management apparatus 2000 allows an individual article that suits a preference to be purchasable by the user 20.

Being able to easily select an individual article that suits a preference in such a manner is particularly suitable for a product in which a variation of each individual article is more likely to occur. For example, an example of the product in which a variation of each individual article is more likely to occur includes a product (a so-called handmade product) being manually made. Specifically, the examples include furniture, a stuffed toy, shoes, a bag, pottery, an art piece (such as a painting, and a sculpture), and the like. In addition, for example, the example of the product in which a variation of each individual article is more likely to occur includes perishable foods (such as vegetables and fruit, meat, seafood, or the like). In addition, for example, the example of the product in which a variation of each individual article is more likely to occur includes a living creature. More specifically, the examples include a pet sold at a pet shop, fish such as a colored carp and a goldfish, and a plant such as a bonsai and a potted plant. In addition, for example, the examples of the product in which a variation of each individual article is more likely to occur include various components used for assembling and manufacturing a product.

However, a product whose individual article can be selected via the individual article management apparatus 2000 may be any product in which a plurality of individual articles are present, and is not limited to a product in which a variation of each individual article is more likely to occur.

### <Method of Managing Information Related to Individual Article>

In order for the user 20 to be able to select an individual article that suits a preference, information about an individual article needs to be managed. Hereinafter, the information related to an individual article is referred to as individual article information. The individual article information includes at least product identification information, individual article identification information, an individual article image (a captured image of an individual article), and attribute information (information representing an attribute of the individual article).

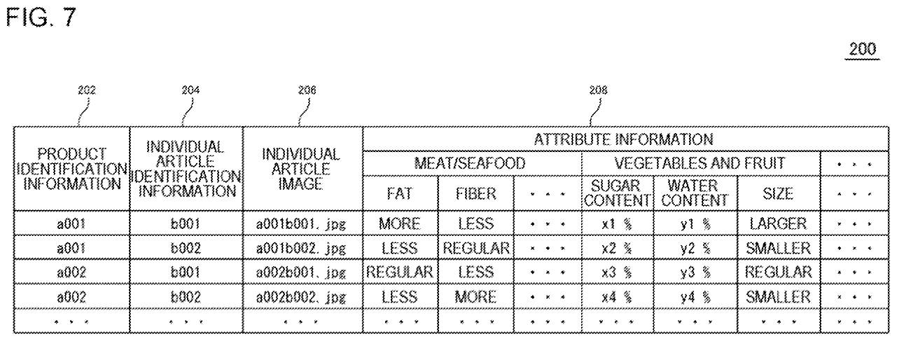

FIG. 7 is a diagram illustrating individual article information in a table format. The table illustrated in FIG. 7 is referred to as a table 200. The table 200 includes four columns of product identification information 202, individual article identification information 204, an individual article image 206, and attribute information 208.

The product identification information 202 is identification information about a product to which an individual article belongs. The individual article identification information 204 is information for identifying an individual article from another individual article. The individual article image 206 is a captured image acquired by capturing an individual article by a camera.

The attribute information 208 indicates, for one or more attributes (features), an attribute value of an individual article having the attribute. One of uses of the attribute information 208 is use for determining whether an individual article suits a preference of a user. Various pieces of information representing a feature of an individual article can be adopted for an attribute indicated by the attribute information 208. For example, an amount (such as grams of meat, and the number of slices of fish), an amount of fat, a size per one slice, an amount of fiber, a water content, and the like can be adopted for an attribute of meat and seafood. In addition, for example, a sugar content, a water content, a size, a degree of maturity, an amount of darkening, and the like can be adopted for an attribute of vegetables and fruit. In addition, for example, darkness of color, a size and an amount of grain, and the like can be adopted for an attribute of furniture. In addition, for example, an expression (such as “smiling”, and “determined”), hardness, a feel, and the like can be adopted for an attribute of a stuffed toy. In addition, for example, a pattern, a size, and the like can be adopted for an attribute of a pet.

Further, a feature related to a storage state of an individual article can also be adopted as an attribute of the individual article. For example, temperature, humidity, illuminance, and the like around an individual article are handled as an attribute of the individual article. Note that, temperature and the like of a storage place may change. Then, as an attribute value of an attribute related to the storage state, for example, a history of values (a list of measured values) being measured by a sensor may be used, or a statistic (such as an average value) of a measured value may be used.

Further, as an attribute of an individual article, a feature related to time such as a date of manufacture (the number of elapsed days since birth in a case of a living creature), a delivery date, an expiration date, and a guarantee period can also be adopted. In addition, for example, presence or absence of a scratch can also be adopted as an attribute of an individual article.

Herein, among the various attributes described above, there is an attribute for which a preference is less likely to differ, such as an amount of fiber in meat and seafood, an amount of darkening of vegetables and fruit, and presence or absence of a scratch of furniture and the like. For example, in general, absence of a scratch is considered preferable. However, for the attributes, by indicating, in the preference information 30, that even an individual article having a generally unpreferred feature has no problem (“no problem even with presence of a scratch”, and the like), a product discounted due to presence of such a feature can be recommended to the user 20. More specifically, processing is achieved, such as processing of also including information about an individual article of furniture with presence of a scratch in the output information 40 when a preference such as “no problem even with presence of a scratch” is indicated by the preference information 30, and, on the other hand, including only information about an individual article of furniture with absence of a scratch in the output information 40 when a preference such as “no problem even with presence of a scratch” is not indicated by the preference information 30.

The information included in the individual article information is not limited to only the information described above. For example, the individual article information may include a selectable flag indicating whether an individual article is in a purchasable state. For example, when a certain individual article is not yet purchased, and the individual article is located in a stockroom, a selectable flag of the individual article is set to “selectable”. Then, when the individual article is purchased or moved from the stockroom to a salesroom, a value of a selectable flag of the individual article is changed from “selectable” to “unselectable”.

For example, the individual article management apparatus 2000 includes, in the output information 40, only an individual article indicated by a selectable flag that the individual article can be selected via the individual article management apparatus 2000. In this way, a product being already purchased by another user and an individual article displayed in a salesroom at a store can be set in such a way that the product and the individual article cannot be selected via the individual article management apparatus 2000.

Herein, when an individual article is moved from a stockroom to a salesroom, a value of a selectable flag needs to be changed. This operation is performed by, for example, a salesclerk who performs an operation of moving an individual article to a salesroom. For example, a salesclerk performs processing (for example, processing of reading a tag in which individual article identification information is recorded) of determining an individual article to be moved to a salesroom by using some sort of terminal (for example, a portable terminal possessed by the salesclerk). Hereinafter, the terminal is referred to as a salesclerk terminal. The salesclerk terminal transmits the read individual article identification information to the individual article management apparatus 2000. The individual article management apparatus 2000 changes, to unselectable, a selectable flag of individual article information indicating the individual article identification information received from the salesclerk terminal.

A method of determining an individual article to be moved to a salesroom is not limited to a method using a salesclerk terminal. For example, a reader that reads individual article identification information provided to an individual article is installed at an exit of a stockroom, a salesroom, and the like. In this way, individual article identification information about an individual article passing through the exit of the stockroom and an individual article displayed in the salesroom is read by the reader. Then, by setting the individual article identification information read by the reader in such a way as to be transmitted to the individual article management apparatus 2000, a salesclerk can change, to unselectable, a selectable flag of each individual article moved to the salesroom without performing an explicit operation.

Note that, an apparatus that performs processing of updating a selectable flag is not limited to the individual article management apparatus 2000. Updating of a selectable flag can be performed by any apparatus that can access a storage device that stores individual article information.

### <Method of Generating Individual Article Information>

There are various methods of generating individual article information. For example, it is assumed that an individual article is delivered from a maker who manufactures the individual article to a place (hereinafter, an individual article management place) where an individual article selectable via the individual article management apparatus 2000 is managed. For example, the individual article management place is a stockroom of a store, and the like. In this case, for example, individual article information is generated through an inspection operation of the individual article delivered to the individual article management place. Specifically, individual article information is generated by inputting information related to an inspected product by an operator (hereinafter, an inspection operator) who performs an inspection.

First, an inspection operator reads, by using a terminal (hereinafter, an inspection terminal) used for an inspection operation, product identification information about an individual article to be inspected. Herein, an existing technique can be used as a method of reading product identification information about an individual article to be inspected. For example, when a JAN code is used as product identification information, the product identification information can be read by reading a bar code provided to an individual article by a bar code reader.

Furthermore, an inspection operator adds, to an individual article to be inspected, individual article identification information about the individual article. For example, individual article identification information is stored in advance in a storage medium (such as an IC tag) attachable to an individual article, the storage medium is attached to an individual article, and thus the individual article identification information is added to the individual article. Note that, a detailed method of adding individual article identification information to an individual article will be described later.

Further, an inspection operator captures an individual article to be inspected by using a camera provided in an inspection terminal. A captured image generated as a result is used as an individual article image. Note that, capturing of an individual article may be automatically performed instead of a manual operation by an operator. For example, when an individual article is passed on a belt conveyor, a camera for capturing an individual article is installed in a predetermined position of the belt conveyor, and capturing of an individual article is set in such a way as to be automatically performed by the camera. An existing technique can be used as a technique for automatically capturing by a camera.

Attribute information about an individual article is input by an inspection operator, for example. In addition, for example, an attribute that can be determined by appearance may be determined by performing an image analysis on an individual article image. In addition, for example, when a sensor is used for determining an attribute value (for example, a sugar content, a water content, and the like), a measurement is performed, by using a sensor by an inspection operator, on an individual article to be inspected, and a measured value is set as attribute information. However, a measurement by a sensor may be automatically performed. For example, a sensor is installed in a predetermined position of a belt conveyor on which an individual article is passed, and a measurement is set in such a way as to be automatically performed when an individual article passes through the place. An existing technique can be used as a technique for automatically performing a measurement by a sensor.

Individual article information is stored in a storage device that can be accessed from the individual article management apparatus 2000. For example, a database for managing individual article information is generated, and individual article information about each individual article is registered in the database. For example, registration of individual article information is performed by an inspection terminal.

As described above, individual article identification information is added to each individual article. Various methods of adding individual article information to an individual article can be adopted. For example, individual article identification information is stored in advance in a storage medium attachable to an individual article, such as an IC tag. Then, the storage medium that stores the individual article identification information about the individual article is attached to the individual article. In this case, by reading the individual article identification information from the storage medium attached to the individual article, the individual article can be determined.

In addition, for example, individual article identification information may be converted into a code such as a bar code and a QR code (registered trademark), and a medium (such as a sticker) on which the code is printed may be attached to an associated individual article. In this case, the individual article identification information about the individual article can be read by reading the code attached to the individual article by a code reader and the like.

In addition, for example, a medium (such as a sticker) on which a character string representing individual article identification information is printed may be attached to an individual article. In this case, for example, the individual article identification information about the individual article can be determined by capturing the medium attached to the individual article by a camera, and performing character recognition on the acquired captured image.

Note that, information other than individual article identification information may be added to an individual article by a similar method. For example, an individual article image is also added to an individual article by a similar method to that of individual article identification information and the like. For example, an individual article image of an individual article is stored in advance in a storage medium attached to the individual article.

A method of generating individual article information is not limited to a method of generating individual article information during an inspection operation. For example, individual article information may be generated by a maker of a manufacturer of a product. For example, individual article information may be generated by an operator who performs an operation of preparing an individual article to be shipped when the individual article is shipped from a maker of a manufacturer, or may be generated by capturing an image of an individual article when the individual article is transported on a conveyor in a manufacturing process. Note that, as a specific generation method, a method similar to the method through an inspection operation described above can be adopted. Herein, an individual article image generated by a maker of a manufacturer may also be used for an inspection operation by the maker of the manufacturer. For example, it is conceivable that an inspection operation of each individual article is performed by comparing an image of each individual article with a reference image.

Individual article information generated by a maker of a manufacturer is managed in a storage device managed by a server provided by the maker of the manufacturer of a product, for example. In this case, the individual article management apparatus 2000 can acquire individual article information about each individual article by accessing the server. However, the individual article information may be managed in a form of being able to be acquired by the individual article management apparatus 2000, and a storage place of the individual article information is not limited to the example described above.

In this way, when individual article information is generated at a time of shipping of a product, it is suitable that the operation of adding individual article identification information and the like to an individual article described above is also performed at the time of shipping of the product. In other words, each individual article in a state where individual article identification information about the individual article and the like are added (for example, in a state where an IC tag that stores individual article identification information is attached) is delivered to an individual article management place.

### <Acquisition of Product Identification Information 10: S102 and S204 to S208>

The acquisition unit 2020 acquires the product identification information 10 about a target product (S102). The target product is a product selected by the user 20 from among products selectable by using the individual article management apparatus 2000.

Any method of acquiring the product identification information 10 about a target product by the acquisition unit 2020 can be used. For example, the individual article management apparatus 2000 provides, to the user terminal 60, a selection screen on which a product is selectable (S204). The user 20 performs selection of a product by adding a predetermined operation to the selection screen displayed on the user terminal 60. The user terminal 60 transmits information representing the selected product to the individual article management apparatus 2000 (S206, S208). The product selected herein is handled as a target product. Then, the acquisition unit 2020 acquires the product identification information 10 about the selected product.

For example, it is assumed that the individual article management apparatus 2000 provides a virtual store described above. In this case, for example, the acquisition unit 2020 provides, to the user terminal 60, a screen representing a product in a field of view of the user 20 at the virtual store (S204). The user 20 performs selection of a product by adding a predetermined operation to the screen displayed on the user terminal 60. The user terminal 60 transmits information representing the selected product to the individual article management apparatus 2000 (S206, S208).

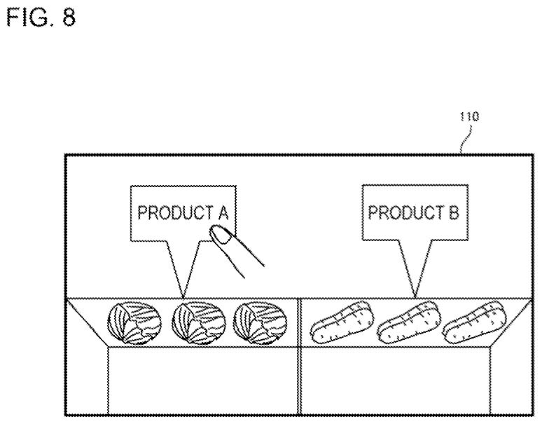

FIG. 8 is a diagram illustrating a screen on which selection of a product can be performed at a virtual store. A screen 110 represents a view included in a field of view of the user 20 at the virtual store. The field of view of the user 20 includes a product A and a product B. Thus, pop-ups representing presence of the product A and the product B are displayed on the screen 110.

The user 20 can select a product by selecting the pop-up through an operation such as a tap and a click. For example, when the user 20 selects the pop-up of the product A, the product A is handled as a target product.

Note that, an operation of selecting a product is not limited to an operation of selecting a pop-up. For example, a product may be selected in response to the product being located at the center of a field of view of the user 20. In other words, the user 20 moves a field of view in such a way that a product desired to be selected is located at the center of the field of view of the user 20. At this time, a mark representing the center of a field of view may be displayed on the screen 110, and a product overlapping the mark may be selected.

As described above, a usage manner of the individual article management apparatus 2000 is not limited to a manner in which a virtual store is provided. For example, it is assumed that the individual article management apparatus 2000 provides a shopping site described above.

In this case, for example, the acquisition unit 2020 provides, to the user 20, a screen on which a product can be searched by a keyword, and a screen on which a product can be selected by following a hierarchical menu (S204). The user 20 performs selection of a product by using the screens. The user terminal 60 transmits information representing the selected product to the individual article management apparatus 2000 (S206, S208). Note that, an existing technique can be used as a specific technique for allowing a product to be selected by a keyword search, and a specific technique for allowing a product to be selected by following a hierarchical menu.

### <Acquisition of Preference Information 30: S104>

The acquisition unit 2020 acquires the preference information 30 about the user 20. For example, the preference information 30 about the user 20 is stored in advance in a storage device that can be accessed from the individual article management apparatus 2000. For example, as a premise for using the individual article management apparatus 2000, the user 20 performs user registration. Herein, at a time of the user registration, user information including various pieces of information related to a user is generated and stored in advance in a storage device that can be accessed from the individual article management apparatus 2000. In the user information, identification information (hereinafter, user identification information) about the user 20 and the preference information 30 about the user 20 are included in advance.

Herein, an apparatus that receives the user registration may be the individual article management apparatus 2000, or may be an apparatus other than the individual article management apparatus 2000. In order to make description clear, it is assumed that the individual article management apparatus 2000 is used for the user registration in the following example.

At a time of the user registration, the individual article management apparatus 2000 receives an input of information related to a preference of the user 20. For example, the individual article management apparatus 2000 provides, to the user terminal 60, an input screen on which various selections related to a preference are performed. The user 20 performs an input of specifying his/her preference on the input screen displayed on the user terminal 60.

The individual article management apparatus 2000 generates user information in which the preference information 30 generated based on the input result and user identification information about the user 20 are associated with each other, and stores the generated user information in a storage device.

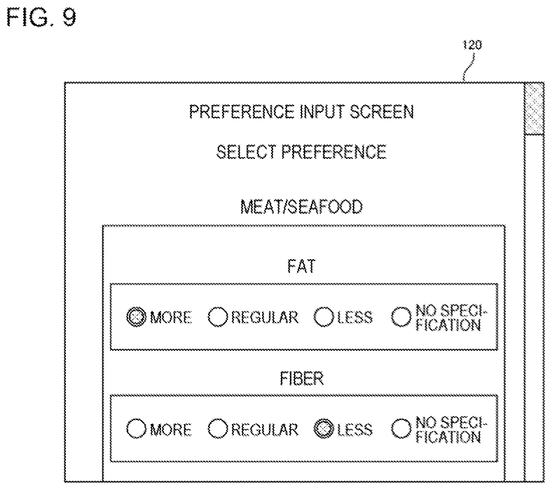

FIG. 9 is a diagram illustrating a screen (preference input screen) for inputting a preference of the user 20. An input interface on which a preference for a product can be selected for each kind of the product is displayed on a preference input screen 120. In the example in FIG. 9, a radio button on which a preference for an amount of fat and an amount of fiber can be input for a product of kinds being “meat/seafood” is displayed. Note that, a preference (i.e., an attribute value) that can be specified by the user 20 for one attribute may be one or more. Further, a preference for an attribute having an attribute value that can be represented as a numerical value, such as a size and an amount, may be specified by one or more numerical values or a range of numerical values.

When the preference information 30 included in user information is registered in advance, the acquisition unit 2020 acquires the preference information 30 associated with user identification information about the user 20. Herein, when user registration is performed in such a manner, the user 20 performs a login when using the individual article management apparatus 2000. Thus, the acquisition unit 2020 can recognize user identification information about the user 20 who performs a login.

The preference information 30 does not necessarily need to be registered in advance. For example, the individual article management apparatus 2000 provides, to the user terminal 60, an input screen that receives an input representing a preference of the user 20 when, before, or after selection of a target product is received from the user 20 (S210). The user terminal 60 receives, from the user 20, the input of the preference to the input screen (S212). The user terminal 60 transmits the input information to the individual article management apparatus 2000 (S214). Further, the individual article management apparatus 2000 may receive an input of the preference information 30 when the user 20 starts using the individual article management apparatus 2000 (when the user 20 logs into a virtual store or a shopping site).

Note that, when a preference input screen is provided after selection of a target product is received, it is suitable that the preference input screen allows an input of only a preference related to the selected target product. For example, when a selected product is a cabbage, a preference input screen that allows an input of only a preference (for example, a preference related to vegetables and fruit) related to a cabbage is provided. By selecting only a preference for a product selected in such a manner, there is an advantage for the user 20 that labor for selecting a preference is reduced.

### <Generation of Output Information 40: S106>

The generation unit 2040 generates, based on the preference information 30, the output information 40 related to an individual article of a target product (S106). For example, the generation unit 2040 determines an individual article that suits a preference of the user 20 represented in the preference information 30 from among individual articles of a target product, and generates the output information 40 including information (for example, the whole individual article information about the determined individual article) about the determined individual article. In this case, for example, by comparing, for each individual article of a target product, attribute information included in individual article information about the individual article with the preference information 30 about the user 20, the generation unit 2040 determines an individual article (i.e., an individual article that suits a preference of the user 20) including the attribute information having a high degree of association with the preference information 30.

More specifically, the generation unit 2040 computes a degree of association between attribute information and the preference information 30 for each individual article (a method of computing a degree of association will be described later). Then, the generation unit 2040 determines the attribute information having a high degree of association with the preference information 30, based on the computed degree of association. For example, the generation unit 2040 determines the attribute information whose degree of association with the preference information 30 is equal to or more than a predetermined threshold value, and handles an individual article including the attribute information as an individual article including the attribute information having a high degree of association with the preference information 30. In addition, for example, the generation unit 2040 determines the attribute information within a predetermined rank in descending order of a degree of association with the preference information 30, and handles an individual article including the attribute information as an individual article including the attribute information having a high degree of association with the preference information 30.

In addition, for example, the generation unit 2040 generates the output information 40 in such a way that an individual article that suits a preference of the user 20 represented in the preference information 30 is preferentially displayed. For example, as described above, the generation unit 2040 computes a degree of association between the attribute information and the preference information 30 for each individual article. Then, the generation unit 2040 generates the output information 40 in such a way that an individual article associated with the attribute information having a higher degree of association with the preference information 30 is more preferentially displayed. For example, it is assumed that the generation unit 2040 includes individual article information about each individual article in the output information 40. In this case, the generation unit 2040 includes, in the output information 40, the individual article information about each individual article in descending order of magnitude of a degree of association between attribute information about the individual article and the preference information 30.

Note that, as described later, information about an individual article included in the output information 40 may not be the whole individual article information, and may be a part thereof

### <<Method of Computing Degree of Association>>

The generation unit 2040 computes a degree of association between attribute information about an individual article and the preference information 30. For example, the degree of association is determined by an equation (1) below.

$$\begin{matrix}[ Mathematical 1 ] & \\ r ( s , i ) = {\sum }_{a} f ( s ( a ) , i ( a ) ) & ( 1 )\end{matrix}$$

Herein, s represents the preference information 30 about the user 20, and i represents the attribute information about the individual article. r(s, i) represents a degree of association between the preference information s and the attribute information i. a is an attribute having an attribute value indicated in both of the preference information 30 and the attribute information. s(a) is an attribute value of an attribute a in the preference information s. i(a) is an attribute value of an attribute a in the attribute information i. f is a function that computes a degree of association between compared attribute values. Thus, f(s(a), i(a)) represents a degree of association between the attribute value s(a) and the attribute value i(a).

A method (such as a function) of computing a degree of association between two attribute values is predetermined depending on a kind of an attribute, and the like. For example, when compared attribute values coincide with each other, a value of f( )is set to be more than 0, and, when compared attribute values do not coincide with each other, a value of f( )is set to be equal to or less than 0. Herein, a numerical range for an attribute may be indicated in the preference information 30. In this case, for example, when the attribute value i(a) of the individual article is included in a numerical range s(a) indicated in the preference information 30 for the attribute a, a value of f( )is set to be more than 0, and, when the attribute value i(a) is not included in the numerical range s(a), a value of f( )is set to be equal to or less than 0.

When the equation (1) is used, as a sum total of degrees of association between an attribute value indicated in the preference information 30 and an attribute value indicated in the attribute information about the individual article, a degree of association between the preference information 30 and the attribute information is computed. Note that, a method of computing a degree of association between the preference information 30 and the attribute information is not limited to the method using the equation (1), and various methods of computing a degree of association between two pieces of compared information can be adopted.

For example, a degree of association may be computed in consideration of a degree of importance (weight) of each attribute. In this case, for example, in addition to an attribute value of each attribute, a degree of importance of the attribute is indicated in the preference information 30. Then, in the equation (1), by multiplying a degree of association between the attribute value s(a) and the attribute value i(a) by a weight of the attribute a indicated in the preference information 30, a degree of association between the preference information s and the attribute information i is computed.

### <<Information Related to Each Individual Article to be Included in Output Information>>

Various pieces of information related to an individual article can be included in the output information 40. Information about an individual article to be included in the output information 40 may be the whole information included in individual article information about the individual article, or may be only a part of information included in the individual article information. In the latter case, various pieces of information related to an individual article associated with individual article identification information (or a pair of product identification information and individual article identification information) are included in the output information 40. For example, an individual article image is included in the output information 40. In this way, the user 20 can view an individual article image being output based on his/her preference, and thus the user 20 can more accurately determine an individual article that suits his/her preference.

In addition, for example, attribute information about an individual article is included in the output information 40. The user 20 can more accurately determine an individual article that suits his/her preference by viewing attribute information about each individual article.

However, only a part of information desired to be viewed by the user 20 may be included in the output information 40. For example, by outputting the output information 40 including individual article identification information and an individual article image, the individual article management apparatus 2000 causes the user 20 to perform selection of an individual article image. When the user 20 selects an individual article image by using the user terminal 60, the user terminal 60 transmits, to the individual article management apparatus 2000, individual article identification information associated with the individual article image. Then, the individual article management apparatus 2000 further outputs, to the user terminal 60, another piece of information (such as attribute information) related to the individual article determined in the received individual article identification information. In this way, by outputting attribute information and the like for only an individual article selected by the user 20, a size of the output information 40 can be reduced. Thus, a response of the individual article management apparatus 2000 to access from the user terminal 60 and the like can be made quick.

Further, instead of outputting information related to an individual article for each individual article, information related to a group of individual articles that coincide or are similar in relation to a preference indicated in the preference information 30 may be output for each group. For example, it is assumed that the preference information 30 indicates a preference for a size of a product. In this case, a plurality of individual articles having a coinciding size can be put together in one group. Further, even when sizes do not completely coincide with each other, a plurality of individual articles (for example, a difference in length such as a diameter and a width is equal to or less than a predetermined threshold value) having almost the same size may be put together in one group. Note that, even when individual articles are put together in a group in such a manner, information about each individual article in addition to information about the group may be further included in the output information 40.

### <Outputting of Output Information 40: S216>

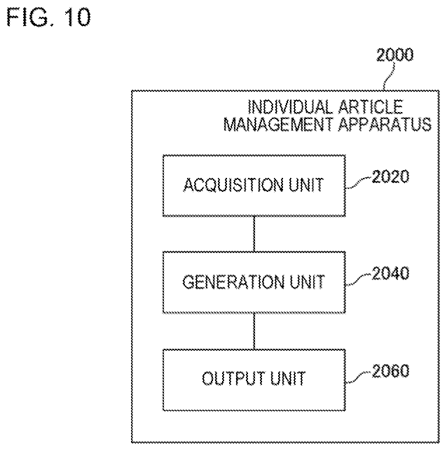

The individual article management apparatus 2000 outputs the generated output information 40 to the user terminal 60 (S216). A functional configuration unit that performs outputting of the output information 40 is referred to as an output unit. FIG. 10 is a diagram illustrating the individual article management apparatus 2000 including an output unit 2060.

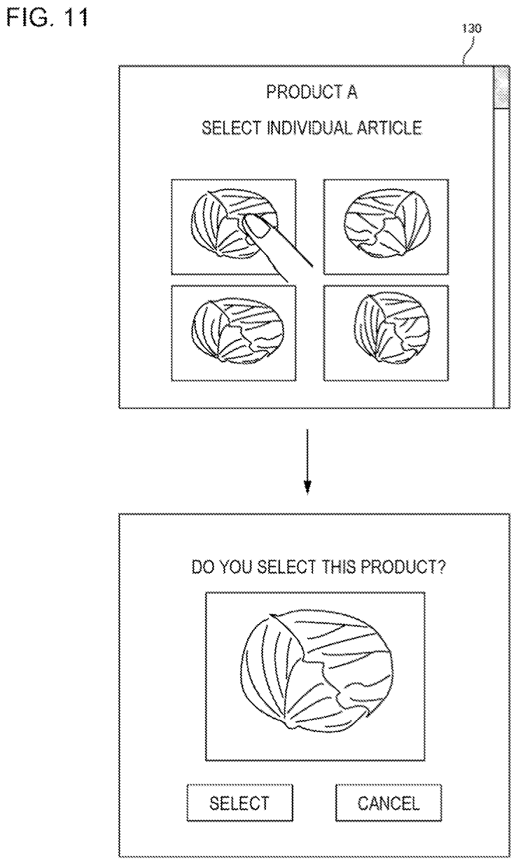

FIG. 11 is a diagram illustrating a screen on which a content of the output information 40 being output is displayed. In FIG. 11, an individual article image included in the output information 40 is displayed on a screen 130. The user 20 can perform an input operation (for example, an operation of tapping on an individual article image) of selecting an individual article image. When an individual article image is selected, the selected individual article image is enlarged and displayed. Further, the user 20 can view detailed information (such as an attribute of an individual article) related to an individual article by further adding an input operation, such as tapping, to the enlarged individual article image. Herein, when the user 20 performs an operation of selecting an individual article, a product thereof is added to an intended purchase list described in an example embodiment described later, for example.

Herein, as described above, it is assumed that a plurality of individual articles are put together in one group. In this case, information about a product is displayed in group unit on the screen 130. For example, one individual article image is displayed for each group. For example, an individual article image of any individual article included in a group is used as an individual article image of the group. The individual article may be randomly selected from the group, or may be selected with a predetermined reference. As the predetermined reference, for example, a reference, such as a reference (such as a numerical value being the smallest or the greatest) for individual article identification information, and a reference (such as presence of an attribute value closest to a statistic of an attribute value computed for a group) for an attribute of interest when a group is formed, can be used.

Note that, in a case where information about a product is displayed in group unit, when the user 20 selects a group, information about each individual article included in the group may be displayed.

### Modification Example

The individual article management apparatus 2000 may be achieved as a system that combines the user terminal 60 and the server 70. In this case, a part of a function of the individual article management apparatus 2000 is provided in the user terminal 60. For example, it is conceivable that information about all individual articles of a target product selected by the user 20 is provided from the server 70 to the user terminal 60, and generation of the output information 40 using the preference information 30 is caused to be performed by the user terminal 60. Hereinafter, the description above is specifically exemplified.

The user terminal 60 receives an input of selecting a target product, and transmits product identification information about the selected product to the server 70. The server 70 transmits, to the user terminal 60, information about all individual articles of the product determined in the received product identification information. For example, the information transmitted herein is a combination of “individual article identification information, attribute information, and an individual article image” for all individual articles of the target product.

The user terminal 60 generates the output information 40 related to an individual article of the target product by using the acquired information and the preference information 30. For example, the user terminal 60 generates the output information 40 including only an individual article image of an individual article that suits a preference of the user 20 among the individual article images acquired from the server 70. Note that, a method similar to a method of generating the output information 40 by the generation unit 2040 described above can be adopted as a method of generating the output information 40 by the user terminal 60.

Furthermore, the user terminal 60 outputs the generated output information 40. For example, the user terminal 60 displays the screen 130 described above and the like on a display device of the user terminal 60.

Note that, as described above, the preference information 30 used by the user terminal 60 may be registered in advance, or may be input around selection of a product, and the like. However, the preference information 30 is stored in a storage device that can be accessed from the user terminal 60. The user terminal 60 acquires the preference information 30 from the storage device, and uses the preference information 30.

### [Example Embodiment 2]

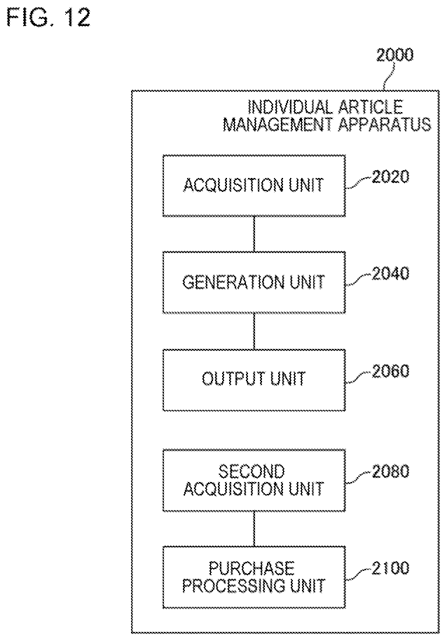

FIG. 12 is a block diagram illustrating a functional configuration of an individual article management apparatus 2000 according to an example embodiment 2. Note that, the individual article management apparatus 2000 according to the example embodiment 2 has a function similar to that of the individual article management apparatus 2000 according to the example embodiment 1 except for a point described below.

The individual article management apparatus 2000 according to the example embodiment 2 includes a second acquisition unit 2080 and a purchase processing unit 2100. The second acquisition unit 2080 acquires individual article identification information about an individual article (an individual article to be purchased by a user 20) selected by the user 20 among individual articles indicated in output information 40. However, when product identification information is also needed for determining an individual article, the second acquisition unit 2080 acquires a pair of the individual article identification information and the product identification information. The purchase processing unit 2100 performs purchase processing on an individual article (i.e., an individual article included in an intended purchase list) determined in the individual article identification information acquired by the second acquisition unit 2080.

For example, the second acquisition unit 2080 outputs, to a user terminal 60, information (for example, the screen 130 in FIG. 11) that prompts an input of selecting an individual article to be purchased. The user terminal 60 receives the input of selecting the individual article to be purchased from among individual articles indicated in the output information 40. For example, the user 20 performs an operation of putting one or more individual articles into a list (hereinafter, an intended purchase list) of individual articles desired to be purchased. The intended purchase list can also be expressed as a shopping cart. The second acquisition unit 2080 acquires individual article identification information about an individual article on which the operation of putting an individual article into the intended purchase list is performed, and adds the individual article identification information to the intended purchase list.

Note that, as described above, the output information 40 may be generated for a group of individual articles. In this case, the user 20 may not select a specific individual article as a purchase target, and may be able to select a group of individual articles. In this case, the second acquisition unit 2080 acquires information that determines the selected group. Furthermore, the second acquisition unit 2080 adds individual article identification information about any individual article included in the group to the intended purchase list. Any reference can be adopted as a reference for selecting one from among a plurality of individual articles included in a group.

Herein, a product may be able to be put in the intended purchase list without specifying an individual article. For example, there are also products in which selection of an individual article is considered unnecessary, such as a product (such as canned goods, a retort product, and confectionery) put in a package whose content cannot be seen, and a product (such as juice in a plastic bottle) having not much difference for each individual article. Then, for such a product, an operation of adding the product to an intended purchase list is received without receiving selection of an individual article. In other words, such a product can be similarly handled as a product purchased at general online shopping.

Note that, for a product in which an individual article is not selected in such a manner, it is suitable that the number of purchases can also be specified in addition to selection of a product. In this case, a combination of product identification information and the number of purchases is added to an intended purchase list.

Further, the number of purchases may also be able to be specified when a group of individual articles is specified. In this case, the second acquisition unit 2080 extracts a specified number of individual articles from the selected group, and adds individual article identification information about the individual article to the intended purchase list. In this way, the user 20 can easily purchase a desired number of individual articles that suit his/her preference.

After selection of an individual article and a product to be purchased by the user 20 ends, the purchase processing unit 2100 performs purchase processing on the individual article included in the intended purchase list. Further, the purchase processing is also performed on a product represented by a combination of product identification information and the number of purchases.

In the purchase processing, payment processing of an individual article and a product in the intended purchase list is performed. For example, in a case of purchase using a credit card, after selection of a credit card registered in advance, an input of credit card information, or the like are performed, a payment of a price using the credit card is performed.

Herein, it is suitable that the user 20 is prompted to confirm an individual article and a product to be purchased before the payment processing is settled. For example, the individual article management apparatus 2000 outputs a confirmation screen to the user terminal 60. It is suitable that an individual article image of each individual article is included in the confirmation screen. In this way, the user 20 can visually reconfirm a feature of a product to be purchased.

Herein, instead of an individual article image (i.e., an individual article image included in individual article information) included in the output information 40, an image representing a latest (current) state of an individual article may be included in the confirmation screen. In this way, the user 20 can confirm a latest state of a selected individual article. Thus, the user 20 can more accurately confirm that a selected individual article suits his/her preference.

An image (hereinafter, a latest individual article image) representing a latest state of an individual article can be acquired by, for example, causing a camera installed at an individual article storage place to capture the individual article. For example, it is assumed that an apparatus (hereinafter, a picking apparatus) that automatically picks an individual article to be purchased by the user 20 from an individual article storage place is provided. The picking apparatus is formed of a robot arm and the like that automatically moves to a specified position, holds an object in the position, and moves the object to a predetermined place, for example. A camera that generates a latest individual article image is provided in advance on the robot arm and the like of the picking apparatus.

When the purchase processing unit 2100 generates a confirmation screen provided to the user 20, the purchase processing unit 2100 transmits individual article identification information about an individual article included in an intended purchase list to the picking apparatus associated with the individual article. The picking apparatus moves the robot arm and the like to a position of the individual article determined in the received individual article identification information, and causes the camera described above to capture the individual article. Then, the picking apparatus transmits the acquired latest individual article image to the purchase processing unit 2100.

The purchase processing unit 2100 outputs the confirmation screen including the latest individual article image to the user terminal 60. The user 20 views the latest individual article image displayed on the user terminal 60, and determines whether to continue a purchase procedure of the associated individual article. Then, the user terminal 60 receives an input of selecting whether to continue the purchase procedure by the confirmation screen including the latest individual article image. The user terminal 60 transmits, to the individual article management apparatus 2000, information representing a result of the received input.

When the information received from the user terminal 60 represents continuation of the purchase procedure, the purchase processing unit 2100 performs the purchase processing by performing the payment processing described above and the like. On the other hand, when the information received from the user terminal 60 does not represent continuation of the purchase procedure, the purchase processing unit 2100 discontinues the payment processing. In this case, for example, the individual article management apparatus 2000 transitions to a state of further receiving selection of an individual article or a state of receiving selection cancellation and the like for the selected individual article.

Note that, instead of a latest individual article image, a video of a current individual article may be included in the confirmation screen. In this case, by using a video camera as the camera described above and causing the video camera to capture an individual article, a video of the individual article can be acquired.

Note that, when a selectable flag is included in individual article information, the purchase processing unit 2100 changes, to unselectable, the selectable flag indicated in the individual article information about an individual article having the purchase processing completed.

### <Example of Hardware Configuration>

For example, a hardware configuration of a computer that achieves the individual article management apparatus 2000 according to the example embodiment 2 is represented in FIG. 3 similarly to the hardware configuration of the computer that achieves the individual article management apparatus 2000 according to the example embodiment 1. However, a program module that achieves a function of each functional configuration unit included in the individual article management apparatus 2000 according to the example embodiment 2 is stored in a storage device 1080 of a computer 1000 that achieves the individual article management apparatus 2000 according to the example embodiment 2.

### <Flow of Processing>

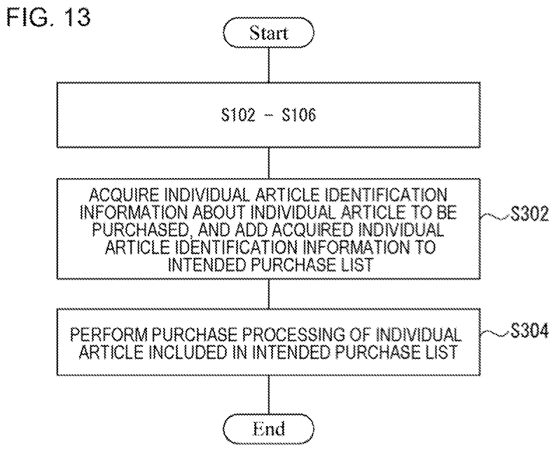

FIG. 13 is a flowchart illustrating a flow of processing performed by the individual article management apparatus 2000 according to the example embodiment 2. After the processing in S102 to S106 illustrated in FIG. 4 is performed, the second acquisition unit 2080 acquires individual article identification information about an individual article to be purchased, and adds the acquired individual article identification information to an intended purchase list (S302). The purchase processing unit 2100 performs purchase processing, based on the intended purchase list (S304). Note that, it is suitable that the processing in S102 to S302 is repeatedly performed until selection of all individual articles and products to be purchased ends. The end of selection of an individual article and the like can be detected in response to, for example, a predetermined operation being performed on the user terminal 60 (for example, a push of a button that specifies that processing proceeds to purchase processing).

### Modification Example

As described above, the individual article management apparatus 2000 may be used for the user 20 who visits a real store to find an individual article located in a stockroom (the usage manner 3 in the example embodiment 1). In this case, the individual article management apparatus 2000 performs processing for providing a selected individual article to the user 20 at the store instead of performing purchase processing of the selected individual article. Specifically, after selection of an individual article by the user 20 ends, the individual article management apparatus 2000 performs processing for picking the selected individual article (an individual article included in the intended purchase list described above) from a stockroom and passing the picked individual article to the user 20.

When picking of an individual article is performed by a salesclerk, the individual article management apparatus 2000 transmits, to a salesclerk terminal, information (individual article identification information and an individual article image) about an individual article selected by the user 20. A salesclerk who possesses the salesclerk terminal which received the information picks the individual article selected by the user 20, and provides the individual article to the user 20. For example, a counter for receiving a product selected by using the individual article management apparatus 2000 is prepared in a store, and the individual article is handed over at the counter.

Picking of an individual article may be automatically performed by the picking apparatus described above. In this case, the individual article management apparatus 2000 transmits, to the picking apparatus, individual article identification information about each individual article selected by the user 20. The picking apparatus picks an individual article associated with the received individual article identification information. The picked individual article is provided to the user 20 at the counter described above, for example.

Note that, when a selectable flag is included in individual article information, the individual article management apparatus 2000 changes, to unselectable, the selectable flag indicated in the individual article information about an individual article handed over to the user 20.

### [Example Embodiment 3]

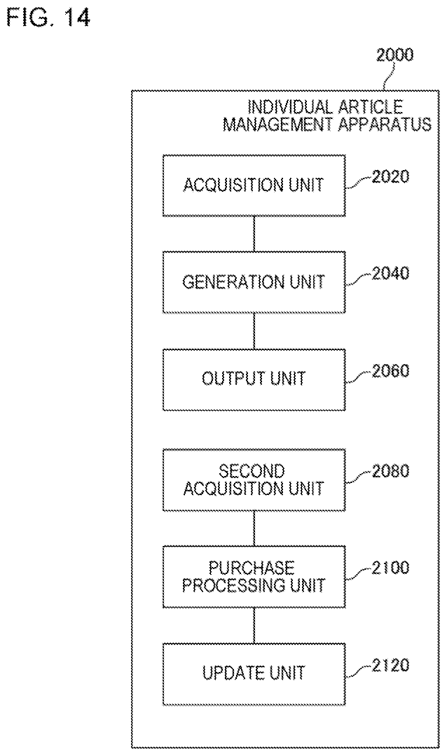

FIG. 14 is a block diagram illustrating a functional configuration of an individual article management apparatus 2000 according to an example embodiment 3. The individual article management apparatus 2000 according to the example embodiment 3 has a function similar to that of the individual article management apparatus 2000 according to the example embodiment 2 except for a point described below.

The individual article management apparatus 2000 according to the example embodiment 3 includes an update unit 2120. The update unit 2120 updates preference information 30 about a user 20, based on information related to an individual article purchased, by the user 20, based on output information 40. For example, the update unit 2120 updates the preference information 30 about the user 20, based on attribute information about an individual article purchased by the user 20. Note that, it is assumed in the individual article management apparatus 2000 according to the example embodiment 3 that the preference information 30 is stored in a storage device.

Various methods can be used for updating of the preference information 30. For example, the update unit 2120 computes, for each attribute indicated in the preference information 30, a statistic of an attribute value in an individual article that has been purchased so far by the user 20, and updates an attribute value of the preference information 30 by the computed statistic. At this time, a statistic may be computed by providing a greater weight to an attribute value of an individual article being more newly purchased.

In addition, for example, the update unit 2120 may update the preference information 30 by using machine learning. In other words, for each attribute of the preference information 30, a learning model for learning an attribute value of the attribute is predetermined. The update unit 2120 inputs, for each attribute of the preference information 30, an attribute value of an individual article purchased by the user 20 to a learning model associated with the attribute. In this way, an attribute value of each attribute of the preference information 30 is updated. Note that, any model can be used as a learning model. Further, learning models used for learning of attributes may be the same as or different from each other. Herein, an existing technique can be used for learning itself using the learning model.

An individual article image may be used for updating of the preference information 30 in relation to an attribute whose attribute value can be computed from an appearance of an individual article. In this case, the update unit 2120 computes, by analyzing the individual article image, an attribute value of each attribute computable from an appearance (i.e., a feature value of the attribute acquired from the image), and updates the preference information 30 with the computed attribute value. Note that, as a method of updating the preference information 30 with a computed attribute value, a method of updating with a statistic described above, a method of updating by machine learning, and the like can be adopted.

### Example of Hardware Configuration

For example, a hardware configuration of a computer that achieves the individual article management apparatus 2000 according to the example embodiment 3 is represented in FIG. 3 similarly to the hardware configuration of the computer that achieves the individual article management apparatus 2000 according to the example embodiment 1. However, a program module that achieves a function of each functional configuration unit included in the individual article management apparatus 2000 according to the example embodiment 3 is stored in a storage device 1080 of a computer 1000 that achieves the individual article management apparatus 2000 according to the example embodiment 3.

### <Flow of Processing>

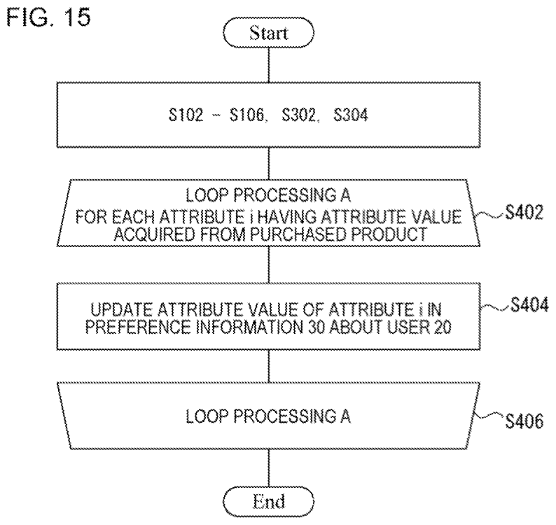

FIG. 15 is a flowchart illustrating a flow of processing performed by the individual article management apparatus 2000 according to the example embodiment 3. After the series of processing illustrated in FIG. 13 is performed, processing after S402 is performed. S402 to S406 is loop processing A performed for each attribute having an attribute value acquired from information (such as individual article information, and an individual article image) related to an individual article purchased by the user 20. In S402, the update unit 2120 determines whether the loop processing A has been performed on all attributes having an attribute value acquired. When the loop processing A has already been performed on all attributes, the processing in FIG. 15 ends. On the other hand, when there is an attribute that has not yet been a target of the loop processing A, a purchase processing unit 2100 selects one of the attributes. Herein, the selected attribute is expressed as an attribute i.

The purchase processing unit 2100 updates, by using an attribute value of the attribute i being acquired from information related to an individual article purchased by the user 20, the attribute value of the attribute i indicated in the preference information 30 about the user 20 (S404). S406 is an end of the loop processing, and thus the loop processing in FIG. 15 returns to S402.

While the example embodiments of the present invention have been described with reference to the drawings, the example embodiments are only exemplification of the present invention, and combination of each of the above-described example embodiments or various configurations other than the above-described example embodiments can also be employed.

The whole or part of the example embodiments described above can be described as, but not limited to, the following supplementary notes.

1. An individual article management apparatus, including:

an acquisition unit that acquires identification information about a product and preference information about a user; and

a generation unit that generates, based on the acquired preference information and attribute information about each individual article of a product determined by the acquired identification information, output information including a captured image related to one or more individual articles of the product.

2. The individual article management apparatus according to supplementary note 1, wherein

the generation unit determines one or more individual articles having attribute information associated with the acquired preference information from among a plurality of individual articles of a product determined by the acquired identification information, and generates the output information including a captured image related to the determined individual article.

3. The individual article management apparatus according to supplementary note 1, wherein

the generation unit determines an output order based on a degree of association between the acquired preference information and attribute information about the individual article for each individual article of a product determined by the acquired identification information, and generates the output information by which captured images related to the individual articles are output in the determined output order.

4. The individual article management apparatus according to any one of supplementary notes 1 to 3, further including:

a second acquisition unit that acquires identification information about an individual article selected by the user among individual articles indicated in the output information; and

a purchase processing unit that performs purchase processing of an individual article determined by the acquired identification information.

5. The individual article management apparatus according to supplementary note 4, wherein

the purchase processing unit
outputs, for an individual article selected by the user, a captured image generated after the selection, and
performs, when the individual article is selected to be purchased by the user in response to the output, purchase processing of the individual article.
   6. The individual article management apparatus according to supplementary note 5, wherein,

for an individual article selected by the user, a captured image generated after the selection is generated by a camera provided on an apparatus that takes out the individual article from a storage place.

7. The individual article management apparatus according to any one of supplementary notes 4 to 6, further including

an update unit that updates the preference information about the user, based on an attribute of an individual article on which purchase processing is performed by the purchase processing unit.

8. The individual article management apparatus according to supplementary note 7, wherein

the update unit computes, from a captured image of an individual article on which purchase processing is performed, an attribute value of one or more attributes of the individual article, and updates the preference information about the user with the computed attribute value.

9. A control method executed by a computer, including:

an acquisition step of acquiring identification information about a product and preference information about a user; and

a generation step of generating, based on the acquired preference information and attribute information about each individual article of a product determined by the acquired identification information, output information including a captured image related to one or more individual articles of the product.

10. The control method according to supplementary note 9, further including,

in the generation step, determining one or more individual articles having attribute information associated with the acquired preference information from among a plurality of individual articles of a product determined by the acquired identification information, and generating the output information including a captured image related to the determined individual article.

11. The control method according to supplementary note 9, further including,

in the generation step, determining an output order based on a degree of association between the acquired preference information and attribute information about the individual article for each individual article of a product determined by the acquired identification information, and generating the output information by which captured images related to the individual articles are output in the determined output order.

12. The control method according to any one of supplementary notes 9 to 11, further including:

a second acquisition step of acquiring identification information about an individual article selected by the user among individual articles indicated in the output information; and

a purchase processing step of performing purchase processing of an individual article determined by the acquired identification information.

13. The control method according to supplementary note 12, further including:

in the purchase processing step,
outputting, for an individual article selected by the user, a captured image generated after the selection; and
performing, when the individual article is selected to be purchased by the user in response to the output, purchase processing of the individual article.
   14. The control method according to supplementary note 13, further including,

for an individual article selected by the user, generating a captured image generated after the selection by a camera provided on an apparatus that takes out the individual article from a storage place.

15. The control method according to any one of supplementary notes 12 to 14, further including

an update step of updating the preference information about the user, based on an attribute of an individual article on which purchase processing is performed in the purchase processing step.

16. The control method according to supplementary note 15, further including,

in the update step, computing, from a captured image of an individual article on which purchase processing is performed, an attribute value of one or more attributes of the individual article, and updating the preference information about the user with the computed attribute value.

17. A system, including:

a user terminal; and

an individual article management apparatus, wherein

the user terminal
receives an input of selecting a product from a user, and outputs identification information about the selected product to the individual article management apparatus, and
receives an input of preference information related to a preference of the user, and outputs the input preference information to the individual article management apparatus, and

the individual article management apparatus
acquires, from the user terminal, the identification information about the selected product and the preference information about the user, and
generates, based on the acquired preference information and attribute information about each individual article of a product determined by the acquired identification information, output information including a captured image related to one or more individual articles of the product.
   18. The system according to supplementary note 17, wherein

the user terminal
acquires the output information, and outputs display based on the output information, and
receives an input of selecting an individual article indicated by the output information, and outputs identification information about the selected individual article to the individual article management apparatus, and

the individual article management apparatus
acquires the identification information about the individual article from the user terminal, and
performs purchase processing of an individual article determined by the acquired identification information.
   19. A program causing a computer to execute each step of the control method according to any one of supplementary notes 9 to 16.

This application is based upon and claims the benefit of priority from Japanese patent application No. 2019-105386, filed on Jun. 5, 2019, the disclosure of which is incorporated herein in its entirety by reference.

### REFERENCE SIGNS LIST

10 Product identification information
20 User
30 Preference information
40 Output information
60 User terminal
70 Server
110 Screen
120 Preference input screen
130 Screen
200 Table
202 Product identification information
204 Individual article identification information
206 Individual article image
208 Attribute information
1000 Computer
1020 Bus
1040 Processor
1060 Memory
1080 Storage device
1100 Input/output interface
1120 Network interface
2000 Individual article management apparatus
2020 Acquisition unit
2040 Generation unit
2060 Output unit
2080 Second acquisition unit
2100 Purchase processing unit
2120 Update unit

What is claimed is:

1. An individual article management apparatus, comprising:
at least one hardware processor configured to implement:
acquiring identification information about a product and preference information about a user; and
generating, based on the acquired preference information and attribute information about each individual article of a product determined by the acquired identification information, output information including a captured image related to one or more individual articles of the product.

2. The individual article management apparatus according to claim 1, wherein
the at least one hardware processor is further configured to determine one or more individual articles having attribute information associated with the acquired preference information from among a plurality of individual articles of a product determined by the acquired identification information, and generate the output information including a captured image related to the determined individual article.

3. The individual article management apparatus according to claim 1, wherein
the at least one hardware processor is further configured to determine an output order based on a degree of association between the acquired preference information and attribute information about the individual article for each individual article of a product determined by the acquired identification information, and generate the output information by which captured images related to the individual articles are output in the determined output order.

4. The individual article management apparatus according to claim 1, wherein the at least one processor is further configured to implement:
acquiring identification information about an individual article selected by the user among individual articles indicated in the output information; and
performing purchase processing of an individual article determined by the acquired identification information.

5. The individual article management apparatus according to claim 4, wherein
the at least one hardware processor is further configured to
output, for an individual article selected by the user, a captured image generated after the selection, and
perform, when the individual article is selected to be purchased by the user in response to the output, purchase processing of the individual article.

6. The individual article management apparatus according to claim 5, wherein,
for an individual article selected by the user, a captured image generated after the selection is generated by a camera provided on an apparatus that takes out the individual article from a storage place.

7. The individual article management apparatus according to claim 4, wherein the at least one processor is further configured to implement
updating the preference information about the user, based on an attribute of an individual article on which purchase processing is performed.

8. The individual article management apparatus according to claim 7, wherein
the at least one hardware processor is further configured to compute, from a captured image of an individual article on which purchase processing is performed, an attribute value of one or more attributes of the individual article, and update the preference information about the user with the computed attribute value.

9. A control method executed by a computer, comprising:
acquiring identification information about a product and preference information about a user; and
generating, based on the acquired preference information and attribute information about each individual article of a product determined by the acquired identification information, output information including a captured image related to one or more individual articles of the product.

10. A system, comprising:
a user terminal; and
an individual article management apparatus, wherein
the user terminal
receives an input of selecting a product from a user, and outputs identification information about the selected product to the individual article management apparatus, and
receives an input of preference information related to a preference of the user, and outputs the input preference information to the individual article management apparatus, and
the individual article management apparatus
acquires, from the user terminal, the identification information about the selected product and the preference information about the user, and
generates, based on the acquired preference information and attribute information about each individual article of a product determined by the acquired identification information, output information including a captured image related to one or more individual articles of the product.

11. (canceled)

12. The control method according to claim 9, further comprising,
determining one or more individual articles having attribute information associated with the acquired preference information from among a plurality of individual articles of a product determined by the acquired identification information, and generating the output information including a captured image related to the determined individual article.

13. The control method according to claim 9, further comprising,
determining an output order based on a degree of association between the acquired preference information and attribute information about the individual article for each individual article of a product determined by the acquired identification information, and generating the output information by which captured images related to the individual articles are output in the determined output order.

14. The control method according to claim 9, further comprising:
acquiring identification information about an individual article selected by the user among individual articles indicated in the output information; and
performing purchase processing of an individual article determined by the acquired identification information.

15. The control method according to claim 14, further comprising:
outputting, for an individual article selected by the user, a captured image generated after the selection; and
performing, when the individual article is selected to be purchased by the user in response to the output, purchase processing of the individual article.

16. The control method according to claim 15, further comprising,
for an individual article selected by the user, generating a captured image generated after the selection by a camera provided on an apparatus that takes out the individual article from a storage place.

17. The control method according to claim 14, further comprising
updating the preference information about the user, based on an attribute of an individual article on which purchase processing is performed.

18. The control method according to claim 17, further comprising,
computing, from a captured image of an individual article on which purchase processing is performed, an attribute value of one or more attributes of the individual article, and updating the preference information about the user with the computed attribute value.

19. The system according to claim 10, wherein
the user terminal
acquires the output information, and outputs display based on the output information, and
receives an input of selecting an individual article indicated by the output information, and outputs identification information about the selected individual article to the individual article management apparatus, and
the individual article management apparatus
acquires the identification information about the individual article from the user terminal, and
performs purchase processing of an individual article determined by the acquired identification information.
